(19) United States
(12) Patent Application Publication
(10) Pub. No.: US 2023/0245175 A1
(43) Pub. Date: Aug. 3, 2023

(54) SYSTEMS AND METHODS TO IDENTIFY A TARGET AUDIENCE FOR PROSPECTIVE CONTENT BASED ON A TAXONOMY

(71) Applicant: Solsten, Inc., St. Paul, MN (US)

(72) Inventors: Joseph Jack Schaeppi, Maple Grove, MN (US); Jonna Maarit Koivisto, Berlin (DE); Lloyd William West, Berlin (DE)

(21) Appl. No.: 17/592,257

(22) Filed: Feb. 3, 2022

(51) Int. Cl. G06Q 30/02; G06F 16/9535

(52) U.S. Cl. CPC G06Q 30/0269; G06Q 30/0204; G06F 16/9535

(57) ABSTRACT

Systems and methods to identify a target audience for prospective content based on a taxonomy are disclosed. Exemplary implementations may: receive a content definition for prospective content; identify a set of the pieces of content based on similarity between taxonomical classifications of the individual pieces of content and the taxonomical classification of the prospective content as indicated by the content definition; correlate one or more combinations of psychological parameter values with the prospective content based on interaction information for the set of pieces of content and the psychological parameter values included in psychological profiles of users that interacted with the set of pieces of content; identify a set of prospective users for the prospective content based on the correlated one or more combinations of psychological parameter values and the psychological profiles of the users; and effectuate presentation of the psychological parameter values of the set of the prospective users.

### FIELD OF THE DISCLOSURE

The present disclosure relates to systems and methods to identify a target audience for prospective content based on a taxonomy.

### BACKGROUND

Online platforms may be dynamic to tailor their content to individual subjects. In some instances, developers of digital environments may seek particular target audiences for their digital environments to ensure continuous interaction. In some instances, the developers may seek the particular target audiences first to develop the digital environments for those target audiences.

### SUMMARY

One aspect of the present disclosure relates to a system configured to identify a target audience for prospective content based on a taxonomy. The system may include electronic storage, one or more hardware processors configured by machine-readable instructions, and/or other elements. Machine-readable instructions may include one or more instruction components. The instruction components may include computer program components. The instruction components may include one or more of content definition receiving component, content identifying component, correlation component, presentation effectuation component, prospective user identifying component, and/or other instruction components.

The electronic storage may be configured to store taxonomical classifications of individual pieces of content. Individual taxonomical classifications may include content parameter values for content parameters that define classifications for the individual pieces of content, psychological profiles for users of digital environments, interaction information that characterizes interactions between users and the pieces of content via the digital environments, and/or other information. The taxonomical classifications may conform to a taxonomy that defines a hierarchical system of the content parameters that facilitate providing the pieces of content with the classifications. The pieces of content may be defined by the content parameter values for some or all of the content parameters. The psychological profiles may include psychological parameter values for psychological parameters.

The content definition receiving component may be configured to receive, via a client computing platform, a content definition for prospective content. The content definition may include content parameter values to a set of the content parameters for the prospective content.

The content identifying component may be configured to identify a set of the pieces of content based on similarity between the taxonomical classifications of the individual pieces of content and the taxonomical classification of the prospective content as indicated by the content definition.

The correlation component may be configured to correlate one or more combinations of psychological parameter values with the prospective content based on the interaction information for the set of pieces of content and the psychological parameter values included in the psychological profiles of the users that interacted with the set of pieces of content.

The prospective user identifying component may be configured to identify a set of prospective users for the prospective content based on the correlated one or more combinations of psychological parameter values and the psychological profiles of the users.

The presentation effectuation component may be configured to effectuate, via the client computing platform, presentation of the psychological parameter values for the psychological parameters of the set of the prospective users.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to identify a target audience for prospective content based on a taxonomy, in accordance with one or more implementations.

FIG. 2 illustrates a method to identify a target audience for prospective content based on a taxonomy, in accordance with one or more implementations.

FIG. 3 illustrates an example implementation of the system configured to identify a target audience for prospective content based on a taxonomy, in accordance with one or more implementations.

FIG. 4 illustrates an example implementation of the system configured to identify a target audience for prospective content based on a taxonomy, in accordance with one or more implementations.

### DETAILED DESCRIPTION

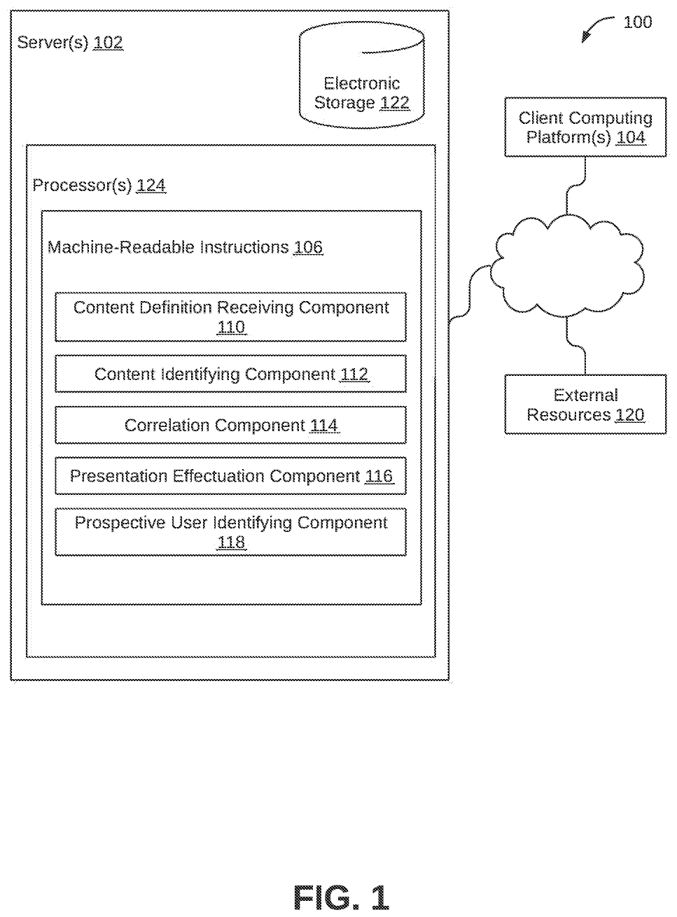

FIG. 1 illustrates a system 100 configured to identify a target audience for prospective content based on a taxonomy, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of content definition receiving component 110, content identifying component 112, correlation component 114, presentation effectuation component 116, prospective user identifying component 118, and/or other instruction components.

Electronic storage 122 may be configured to store taxonomical classifications of individual pieces of content, psychological profiles for users of digital environments, and interaction information, and/or other information. The pieces of content may include a character, a game, a game asset, a recommendation, a suggestion, a promotion, and/or other pieces of content. The character may refer to an object (or group of objects) present in a virtual space that corresponds to an individual subject (e.g., an avatar) and/or are controlled by the subject. In some implementations, the character may not correspond to an individual subject but rather provide information (e.g., the recommendation, the suggestion) to the subject. The game asset may include a virtual item, a virtual resource (e.g., weapon, tool), of in-game powers, in-game skills, in-game technologies, and/or other game assets. The recommendation may include a particular selection and/or action that the subject is advised to select and/or do. The suggestion may include particular ideas, plans, and/or strategies for the subject to consider executing, following, and/or is determined they will enjoy. The promotion may include discount codes, coupons, bonuses, and/or other promotions of the virtual items, products, and/or services that the subject may utilize. By way of non-limiting example, products and/or services may relate to beauty (e.g., skincare, makeup), home improvement, decoration, clothing, accessories, technology, kitchen, and/or other categories.

Individual taxonomical classifications may include content parameter values for content parameters that define classifications for the individual pieces of content. The taxonomical classifications may conform to a taxonomy that defines a hierarchical system of the content parameters that facilitate providing the pieces of content with the classifications. The pieces of content may be defined by the content parameter values for some or all of the content parameters.

Some of the content parameters may be high order parameters and some of the content parameters may be lower order parameters. That is, a high order parameter may include more specific lower order parameters where the content parameter values more specifically describe the content as the content parameter values exist for the lower order parameters. In some implementations, a parameter may be one or more hierarchical orders within the taxonomy. The content parameters may include genre, platform-specific genre, mechanics, theme, art style and perspective, brand intellectual property, modes, churn, marketing assets, creative elements, and/or other content parameters. Such content parameters may be the higher order parameters of the content parameters.

The genre may include action, action-adventure, adventure, role-playing, simulation, strategy, sports, puzzle, casino, serious game, arcade, and/or other genres. The action genre may include battle royale, fighting, platformer, rhythm, shooter, vehicular combat, and/or other action genres. The fighting genre may include beat-em up/brawler, hero fighter, real-time, story-based, team-based, turn-based, and/or other fighting genres. The rhythm genre may include Band, Dance, Instrument, Singing, and/or other rhythm genres. The shooter genre may include first-person shooter (FPS), hero shooter, loot shooter, platform shooter, tactical shooter, third-person shooter (TPS), top-down shooter, and/or other shooter genres. The first-person shooter (FPS) genre may include arena shooter, cooperative shooter, corridor shooter, and/or other first-person shooter (FPS) genres. The vehicular combat genre may include aircraft, car, mecha, motorcycle, multi-vehicular, spacecraft, tank, warship and submarine, and/or other vehicular combat genres.

The action-adventure genre may include action-adventure platformer, combat action-adventure, puzzle action-adventure, survival, and/or other action-adventure genres. The action-adventure platformer genre may include metroidvania, puzzle platformer, and/or other action-adventure platformer genres. The combat action-adventure genre may include hack and slash, shooter, stealth, and/or other combat action-adventure genres. The puzzle action-adventure genre may include open world, story driven, and/or other puzzle action-adventure genres. The survival genre may include open world, story driven, survival horror, and/or other survival genres. The open world genre may include procedural and/or other open world genres.

The adventure genre may include interactive art, interactive drama, interactive fiction, point-and-click adventure, puzzle adventure, and/or other adventure genres. The interactive art genre may include interactive movie, walking simulator, and/or other interactive art genres. The interactive fiction genre may include text adventure, visual novel, and/or other interactive fiction genres.

The role-playing genre may include action RPG, action-adventure RPG, casual RPG, dungeon crawler, MMORPG, sandbox RPG, tactical RPG, and/or other role-playing genres. The action RPG genre may include hack and slash, shooter, and/or other action RPG genres. The dungeon crawler genre may include dungeon RPG (party-base), rouguelikes, and/or other dungeon crawler genres. The MMORPG genre may include alternate reality (AR), player-driven economy, role-based, sandbox, skill-based, and/or other MMORPG genres.

The simulation genre may include building simulation, management simulation, MMO simulation, role-playing simulation, vehicle simulation, and/or other simulation genres. The building simulation genre may include city building and management, farming simulation, renovation simulation, and/or other building simulation genres. The management simulation genre may include breeding simulation, ecosystem simulation, government simulation, pet-raising simulation, railroad management, time management, tycoon, and/or other management simulation genres. The tycoon genre may include clicker manager, park simulation, tower-building simulation, and/or other tycoon genres. The MMO simulation genre may include virtual social world and/or other MMO simulation genres. The role-playing simulation genre may include animal simulation, dating simulation, God simulation, hobby simulation, job simulation, recreational simulation, social simulation, weapon simulation, and/or other role-playing simulation. The vehicle simulation genre may include flight simulation, train simulation, tractor simulation, trucking simulation, and/or other vehicle simulation genres.

The strategy genre may include 4×, abstract strategy, auto battler, build & battle, card-based strategy, grand strategy wargame, multiplayer online battle arena (MOBA), real-time strategy (RTS), real-time tactics (RTT), turn-based strategy (TBS), turn-based tactics (TBT), and/or other strategy genres. The card-based strategy may include card battler, card collectable, and/or other card-based strategy genres. The real-time strategy (RTS) genre may include action RTS, MMORTS, tower defense, and/or other real-time strategy (RTS) genres.

The sports genre may include extreme sports, golf, racing, racket sports, sports-based fighting, table sports, team sports, throwing sports, and/or other sport genres. The extreme sports genre may include bike riding, skateboarding, winter sports, and/or other extreme sports genres. The racing genre may include 2D racing, kart racing, manager motorcycle racing, sim racing, and/or other racing genres. The Sim racing genre may include dirt, drifting, NASCAR, off-road, open wheel, rallycross, road, and/or other Sim racing genres. The racket sports genre may include badminton, table tennis, tennis, and/or other racket sports genres. The sports-based fighting genre may include boxing, martial arts, wrestling, and/or other sports-based fighting genres. The table sports genre may include air hockey, billiards, foosball/table football, snooker, and/or other table sports genres. The team sports genre may include baseball, basketball, cricket, (American) football, ice hockey, manager, rugby, soccer, volleyball, and/or other team sports genres. The manager genre may include baseball, basketball, (American) football, ice hockey, rugby, soccer, and/or other manager genres. The throwing sports genre may include bowling, darts, and/or other throwing sports genres.

The puzzle genre may include hidden object game, reveal the picture game, matching, puzzle shooter, block puzzle, logic game, trivia game, word game, and/or other puzzle genres. The reveal the picture game genre may include nonogram, jigsaw, coloring, and/or other reveal the picture game genres. The matching genre may include match 3, tile-matching, card-matching, merge, collapse, and/or other matching genres. The match 3 genre may include story-driven match 3, match 3 renovation, RPG match 3, dungeon crawler match 3, and/or other match 3 genres. The tile-matching genre may include Mahjong, and/or other tile-matching genres. The card-matching genre may include solitaire, rummy, and/or other card-matching genres. The puzzle shooter genre may include bubble popper, marble shooter, platform shooter, and/or other puzzle shooter genres. The block puzzle genre may include falling block, tangram, and/or other block puzzle genres. The logic game genre may include connecting game, escape game, maze, memory game, Sokoban, Sudoku, and/or other logic game genres. The word game genre may include crossword, word search, letter arrangement, and/or other word game genres.

The casino genre may include bingo, card, dice, roulette, lottery, slots, and/or other casino genres. The card genre may include blackjack, poker, solitaire, and/or other card genres. The poker genre may include Texas hold'em and/or other poker genres. The dice genre may include craps, liar's dice, Yahtzee, and/or other dice genres. The lottery genre may include Keno, scratch cards, and/or other lottery genres. The slots genre may include city-builder slots, Vegas slots, and/or other slots genres.

The serious game genre may include citizen science, educational, exergame, health, and/or other serious game genres. The exergame genre may include location-based exergame, motion-controlled exergame, VR exergame, and/or other exergame genres. The health genre may include awareness raising, cognitive training, health improvement, stress reduction, and/or other health genres.

The arcade genre may include action, party, pinball, and/or other arcade genres. The action genre may include endless running, multiplayer elimination, single screen, shoot 'em up (STG), shooting gallery, and/or other action genres. The endless running genre may include 3D endless runner, gravity tapper, side-scrolling, and/or other endless running genres. The single screen genre may include slicing game, platformer, and/or other single screen genres. The party genre may include charades, mini challenges, trivia, and/or other party genres.

The platform-specific genre may include action, adventure, arcade, AR games, bingo, board, brain, card, casino, casual, classic, club, dice, educational, family, fighting, first person, fitness, flying, hidden object, horror, indie, kids, Mahjong, matching, massively multiplayer, multiplayer, music, online, party, platformer, poker, puzzle, racing, role playing, sci-fi, shooter, simulation, slots, solitaire, sports, social, strategy, trivia, word, and/or other platform-specific genres.

The mechanics may include physics, economy, progression, time, actions, social, onboarding, and/or other mechanics. The physics mechanic may include real world physics, non-realistic physics, simple physics, and/or other physics mechanics. The real-world physics mechanic may include realistic movement, environment responsiveness, and/or other real world physics mechanics. The realistic movement mechanic may include realistic gravity and/or other realistic movement mechanics. The environment responsiveness mechanic may include dynamic environment, static environment, and/or other environment responsiveness mechanics. The non-realistic physics mechanic may include physics modifiers, discrete physics, and/or other non-realistic physics mechanics. The physics modifiers mechanic may include items, objects, and/or other physics modifiers mechanics. The discrete physics mechanic may include jump, run, walk, attack, combination attack, and/or other discrete physics mechanics. The simple physics mechanic may include block swap, measurement, and/or other simple physics mechanics. The measurement mechanic may include time, rhythm, sound, and/or other measurement mechanics.

The economy mechanic may include internal economy, monetization, and/or other economy mechanics. The internal economy mechanic may include virtual resources, resource life span, resource source, rewards, feedback, environment factors, and/or other internal economy mechanics. The virtual resources mechanic may include soft currency, hard currency, money, lottery tickets, ammunition, vehicles, fuel, mounts, equipment, weapons, performance boosts, number of moves, cosmetic items, characters, based, buildings, collectibles, emotes, containers, gifts, inventories, UI enhancements, loot boxes, chests, gachas, health, lives, tickets, popularity, energy, humanity indicators, experience, time, hints, secret resources, and/or other virtual resources mechanics. The equipment mechanic may include sports equipment, clothing, protective gear, and/or other equipment mechanics. The performance boosts mechanic may include items, objects, unlimited lives, extra moves, multipliers, boost periods, and/or other performance boosts mechanics. The cosmetic items mechanic may include skins, character animations outfits, accessories, and/or other cosmetic items mechanics. The collectibles mechanic may include collectible cards, collection sets, and/or other collectibles mechanics. The chests mechanic may include timed chests and/or other chests mechanics. The health mechanic may include hit points and/or other health mechanics. The lives mechanic may include plays, tokens, turns, redoes, spins, and/or other lives mechanics. The energy mechanic may include mana, elixir, magical essence, and/or other energy mechanics. The secret resources mechanic may include asymmetric information and/or other secret resources mechanics. The resource life span mechanic may include permanent resources, degrading resources, resource cap, scarcity, consumable, progress loss, and/or other resource life span mechanics. The degrading resources mechanic may include degrading over time, degrading through use, and/or other degrading resources mechanics. The scarcity mechanic may include limited edition, rarity, expiration times, and/or other scarcity mechanics. The progress loss mechanic may include progress loss via level/mission restart, permadeath, and/or other progress loss mechanics. The resource source mechanic may include community members, rewards, loot boxes, growing reward pool, gacha, converting, crafting, exchanging, trading, stealing, raiding, destroying, disassembling, gifting, mining, looting, drops, soft currency via gameplay, soft currency via in-app purchases, soft currency via in-app ads, hard currency via gameplay, hard currency via in-app purchases, hard currency via in-app ads, auction, store, and/or other resource source mechanics. The community members mechanic may include friends, team, guild, and/or other community members mechanics. The gacha mechanic may include complete gacha, box gacha, Sugoroku gacha, redraw gacha, consecutive gacha, step-up gacha, open versus closed gacha, discounted gacha, and/or other gacha mechanics. The rewards mechanic may include individual rewards, shared rewards, reward types, Easter eggs, reward schedule, reward streak, and/or other rewards mechanics. The reward types mechanic may include virtual resources, feedback, and/or other reward types mechanics. The reward schedule mechanic may include daily rewards, immediate rewards, sudden rewards, anticipation rewards, rewards distributed over time, reward dangling, fixed rewards, random rewards, random chance rewards, random opportunity rewards, and/or other reward schedule mechanics. The reward streak mechanic may include yearly reward streak, monthly reward streak, weekly reward streak, daily reward streak, and/or other reward streak mechanics. The feedback mechanic may include verbal feedback, visual feedback, audio feedback, physics feedback, playing style reinforcement, corrective feedback, feedback structures, and/or other feedback mechanics. The verbal feedback mechanic may include dynamic verbal feedback, priming, social norming, and/or other verbal feedback mechanics. The visual feedback mechanic may include hitmarker, crosshair, and/or other visual feedback mechanics. The physics feedback mechanic may include performance boost and/or other physics feedback mechanics. The feedback structures mechanic may include positive feedback, negative feedback, constructive effect, destructive effect, high investment, low investment, high return, low return, immediate feedback, insufficient return, fast feedback, slow feedback, short range, long range, no durability, limited durability, extended durability, extended durability, permanent durability, and/or other feedback structures mechanics. The environment factors mechanic may include atmospheric effects, day-night cycle, and/or other environment factors mechanics. The atmospheric effects mechanic may include weather and/or other atmospheric effects mechanics. The weather mechanic may include fog, rain, and/or other weather mechanics. The monetization mechanic may include downloadable content (DLC), free-to-play (F2P), pay-to-play (P2P), player trading, store, sweepstakes, loyalty program, and/or other monetization mechanics. The free-to-play (F2P) mechanic may include premium, in-app ads, in-app purchases, and/or other free-to-play (F2P) mechanics. The in-app purchases mechanic may include virtual resources, progression, and/or other in-app purchases mechanics. The pay-to-play (P2P) mechanic may include buy-to-play, subscription, battle pass, season pass, and/or other pay-to-play (P2P) mechanics. The store mechanic may include static store, dynamic store, and/or other store mechanics. The dynamic store mechanic may include bundles, dangling prizes, dangling items, dynamic offers, and/or other dynamic store mechanics. The bundles mechanic may include starter pack, free gifts, daily deals, timed deals, and/or other bundles mechanics. The dynamic offers mechanic may include offer deal increase, offer after win state, offer after lose state, personalized discounts, and/or dynamic offers mechanics.

The progression mechanic may include means of progress, increasing complexity, increasing difficulty, decreasing difficulty, adaptive difficulty, difficulty selection, escalation, meaning/purpose, progression indicators, and/or other progression mechanics. The means of progress mechanic may include structured progress, semi-structured progress, and/or other means of progress mechanics. The structured progress mechanic may include story, goals, saga map, battle pass, and/or other structured progress mechanics. The story mechanic may include episodes, seasons, chapters, metaphors, and/or other story mechanics. The goals mechanic may include goal prioritization, goal setting, short-term goals, long-term goals, individual goals, shared goals, missions, quests, to-do lists, treasure hunts, campaigns, challenges, subtasks, unlocking, torture breaks, pay or wait, lock and key, game world expansion, fog of war, milestones, metagame, and/or other goals mechanics. The quests mechanic may include quest list, group quests, and/or other quests mechanics. The challenges mechanic may include daily challenges, seasonal challenges, special events challenges, and/or other challenges mechanics. The milestones mechanic may include dangling milestones and/or other milestones mechanics. The semi-structured progress mechanic may include slow cycle, indirect progress, loss avoidance, elimination, puzzle solving, races, structure building, resource collection, territory control, and/or other semi-structured progress mechanics. The elimination mechanic may include player-vs-player (PVP) and/or other elimination mechanics. The puzzle solving mechanic may include hidden object and/or other puzzle solving mechanics. The resource collection mechanic may include item collection and/or other resource collection mechanics. The difficulty selection mechanic may include game speed selection and/or other difficulty selection mechanics. The escalation mechanic may include escalating challenge, escalating complexity, arms race, escalating resource accumulation, and/or other escalation mechanics. The meaning/purpose mechanic may include unrelated, contrast between appearances and mechanics, intertextual irony, and/or other mean/purpose mechanics. The progression indicators mechanic may include skill tree, perks, trophies, performance statistics, progress bar, timer, timeline, streaks, play session, levels, upgrades, score, experience points, achievements, character growth, player growth, game world map, special events, matches, and/or other progression indicators mechanics. The performance statistics mechanic may include high scores, headshots, assists, rankings, three-star rating, and/or other performance statistics mechanics. The streaks mechanic may include kill streaks and/or other streak mechanics. The levels mechanic may include game level, player level, character level, item level, and/or other levels mechanics. The score mechanic may include perfect score and/or other score mechanics. The achievements mechanic may include achievement badges and/or other achievement mechanics. The character growth mechanic may include learning skills, character status/rank, and/or other character growth mechanics. The player growth mechanic may include player status/rank and/or other player growth mechanics. The game world map mechanic may include game world expansion and/or other game world map mechanics. The matches mechanic may include boss fights and/or other matches mechanics.

The time mechanic may include synchronous time, asynchronous time, real-time, turn-based, and/or other time mechanics. The real-time mechanic may include pause-able real-time and/or other real-time mechanics. The turn-based mechanic may include partially turn-based, combined turn-based and real-time, optionally turn-based, timed turns, time compression, ticks, rounds, active time battle, simultaneously executed, clock-based, unit initiative, turn interrupting, phases, and/or other turn-based mechanics.

The action mechanic may include auction for player (turn) organization, cards, capturing, combat, steering a vehicle, riding a mount, racing, catch-up, dice, movement, roleplaying, strategizing, puzzle solving, caretaking, resource management, worker placement, game world exploration, game time manipulation, modifying the environment, terraforming, spinning a wheel, tiles, coloring, betting, auto play, passing turn, decorating, renovating, merging, collapsing, tapping, point and click interaction, flipping a coin, player-generated content, and/or other action mechanics. The cards mechanic may include shuffle, draw, play, and/or other cards mechanics. The capturing mechanic may include eliminating, converting, kill count, and/or other capturing mechanics. The combat mechanic may include strategic thinking, shooting, casting spells, attacking, defending, destroying, taking cover, dodging, combo actions, and/or other combat mechanics. The strategic thinking mechanic may include building units, commanding units, positioning units, and/or other strategic thinking mechanics. The racing mechanic may include vehicle maintenance, team management, strategizing, and/or other racing mechanics. The catch-up mechanic may include push-back and/or other catch-up mechanic. The dice mechanic may include rolling, randomizer, exploding dice, counting sets, drama dice, keep the two highest, some results are botches, and/or other dice mechanics. The movement mechanic may include realistic movement, non-realistic movement, measurement-based movement, block swap, contextual movement, real-world movement, point and click movement, moving a pawn, and/or other movement mechanics. The realistic movement mechanic may include responsiveness, shooting, jumping, throwing, walking, running, climbing, and/or other realistic movement mechanics. The shooting mechanic may include accurate, aided, and/or other shooting mechanics. The non-realistic movement mechanic may include physics modifiers, modified laws of relativity, discrete physics, and/or other non-realistic movement mechanics. The physics modifiers mechanic may include items, objects, and/or other physics modifiers mechanics. The discrete physics mechanic may include jumping, running, walking, attacking, combination attacking, and/or other discrete physics mechanics. The measurement-based movement mechanic may include time, rhythm, sound, and/or other measurement-based movement mechanics. The puzzle solving mechanic may include logical puzzle solving, memory puzzle solving, word puzzle solving, and/or other puzzle solving mechanics. The word puzzle solving mechanic may include spelling words, linking letters, and/or other word puzzle solving mechanics. The caretaking mechanic may include farming, growing, tending, feeding, and/or other caretaking mechanics. The resource management mechanic may include collecting, mining, looting, crafting, grinding, consuming, building, constructing, selling, buying, trading, time management, exchanging resources, and/or other resource management mechanics. The worker placement mechanic may include worker micromanagement and/or other worker placement mechanics. The game work exploration mechanic may include exploration, navigation, and/or other game work exploration mechanics. The tiles mechanic may include tile-laying, tile-matching, shuffling tiles, and/or other tiles mechanics. The tile-matching mechanic may include linking blocks and/or other tile-matching mechanics. The betting mechanic may include micro betting and/or other betting mechanics. The player-generated content mechanic may include generating content and/or other player-generated content mechanics. The generating content mechanic may include level editing, level creation, item creation, and/or other generating content mechanics.

The social mechanic may include single player, multiplayer, playable characters, non-playable characters, friending, alliance building, in-game community, communication, social interaction, social media integration, sharing gameplay, personalization, out-game community, and/or other social mechanics. The playable characters mechanic may include avatars, species, races, roles, classes, skill/ability specialization, and/or other playable character mechanics. The roles mechanic may include team captain, guild master, dungeon master, team manager, and/or other roles mechanics. The skill/ability specialization mechanic may include profession and/or other skill/ability specialization mechanics. The non-playable characters mechanic may include pets, bots, mentors/assistances, and/or other non-playable character mechanics. The friending mechanic may include friends, friend requests, inviting a friend, friend list, and/or other friending mechanics. The in-game community mechanic may include joining a community and/or other in-game community mechanics. The joining a community mechanic may include guild, clan, faction, league, team, and/or other joining a community mechanics. The team mechanic may include community status, community ranking, community name, community identity, community symbol, and/or other team mechanics. The communication mechanic may include private messaging, group messaging, world messaging, game lobby, in-game voice chat, emotes, emojis, dance moves, gestures, singing, gifting, pining, and/or other communication mechanics. The pinging mechanic may include ping wheel, pinging loot, pinging map, and/or other pinging mechanics. The social interaction mechanic may include competition, collaboration, social recognition, social voting, inviting a player, visiting a player, and/or other social interaction mechanics. The competition mechanic may include battle, tournament, raid, match, leaderboards, and/or other competition mechanics. The match mechanic may include friendly, player vs. player. player vs. environment, team vs. environment, team vs. team, player vs. computer/bot, player matching, team matching, and/or other match mechanics. The player vs. computer/bot mechanic may include near miss, close win, and/or other player vs. computer/bot mechanics. The leaderboards mechanic may include timed leaderboards, global leaderboards, local leaderboards, player leaderboards, community leaderboards, community battle leaderboards, and/or other leaderboards mechanics. The collaboration mechanic may include healing, helping, assisting, trading, gifting, requesting, donating, item dropping, group battle 2v2 battle, and/or other collaboration mechanics. The helping mechanic may include calls for help, notifications for receiving help, notification for having helped, mentoring, sharing knowledge, and/or other helping mechanics. The calls for help mechanic may include times calls for help and/or other calls for help mechanics. The donating mechanic may include donating troops, donating cards, times donation quota, and/or other donating mechanics. The social recognition mechanic may include social achievement recognition, brag buttons, pokes, high fives, likes, and/or other social recognition mechanics. The social voting mechanic may include commending and/or other social voting mechanics. The social media integration mechanic may include prompts encouraging sharing and/or other social media integration mechanics. The prompts encouraging sharing mechanic may include sharing high score, sharing one's performance, and/or other prompts encouraging sharing mechanics. The sharing gameplay mechanic may include streaming, video capturing, screenshot, replays, and/or other sharing gameplay mechanics. The personalization mechanic may include character customization, avatar customization, item customization, environment customization, profile customization, and/or other personalization mechanics. The out-game community mechanic may include developer tagging and/or other out-game community mechanics.

The onboarding mechanic may include learning to play, tutorial, training mode, beginner's luck, content scaffolding, walkthrough (passive) narrative, learning by doing, contextual instruction, personified AI, privacy, and/or other onboarding mechanics. The learning to play mechanic may include action, simulation, feedback, modeling, and/or other learning to play mechanics. The content scaffolding mechanic may include progressive unlocking, progressive UI, and/or other content scaffolding mechanics. The contextual instructions mechanic may include contextual text, prompts, tooltips, glowing choices, and/or other contextual instructions mechanics. The personified AI mechanic may include virtual assistance and/or other personified AI mechanics. The privacy mechanic may include private game mode and/or other privacy mechanics.

The theme may include history, crime/mystery, horror, fighting, warfare, fantasy, science fiction, vehicles, politics, economy, management, lifestyle, infrastructure, society, health, nature, science, space, erotic art, romance, relationships, drama, comedy, animation, anime, symbols & abstract, educational, travel, entertainment, media, family, kids, sports & outdoors, celebrations, holidays, and/or other themes. The history theme may include non-fiction, fiction, centuries and decades, eras and ages, civilizations, medieval, archeology, folklore, and/or other history themes. The non-fiction theme may include autobiography, biography, and/or other non-fiction themes. The biography theme may include coming of age and/or other biography themes. The fiction theme may include alternate history, steampunk, Atlantis, and/or other fiction themes. The centuries and decades theme may include 17^{th} century, 18^{th} century, 19^{th} century, 1910's, 1920's, 1930's, 1940's, 1950's, 1960's, 1970's, 1980's, 1990's, and/or other centuries and decades themes. The eras and ages theme may include Middle Ages, Stone Age, Renaissance, Wild West, Victorian Era, Prohibition-era, Enlightenment, Prehistoric, Bronze Age, Holocaust, Post-Holocaust, and/or other eras and ages themes. The civilizations theme may include Ancient Egypt, Ancient Rome, Ancient Babylon, Aztec, Ancient China, Ancient Greece, and/or other civilization themes. The medieval theme may include castles, royalty, knights, and/or other medieval themes. The folklore theme may include fairy tales, fables, and/or other folklore themes.

The crime/mystery theme may include detective, investigation, thriller, cryptography, espionage, mafia, murder, spy, prison, secret agent, conspiracy, illuminati, and/or other crime/mystery themes.

The horror themes may include psychological horror, gore, and/or other horror themes.

The fighting themes may include combat, fighters, battlefield gore, blood, killing, and/or other fighting themes. The combat theme may include martial arts, stealth, swordfight, wrestling, assassination, and/or other combat themes. The fighters theme may include rogue, assassin, ninja, pirates, Samurai, Vikings, and/or other fighters themes.

The warfare theme may include terrorism, cold war, military, naval, naval combat, bullet hell, sniper, tactical, World War I, World War II, American Indian Wars, American Revolutionary War, Civil War, French and Indian War, Korean War, Modern Warfare, Nautical Combat, Revolutionary War, Vietnam War, Revolution, grand strategy, and/or other warfare themes.

The fantasy theme may include creatures, mythology, magic, supernatural, technology, and/or other fantasy themes. The creature theme may include demons, dragons, vampire, werewolves, zombies, dungeon, maze, monsters, unicorns, ghosts, and/or other creature themes. The mythology theme may include Nordic mythology, Greek mythology, Roman mythology, Asian mythology, and/or other mythology themes. The magic theme may include sorcery, alchemy, casting spells, witches, wizards, mages, shaman, witch doctor, and/or other magic themes. The supernatural theme may include superheroes, supervillains, and/or other supernature themes. The technology theme may include technomancy/techno magic and/or other technology themes.

The science fiction theme may include artificial intelligence, time manipulation, time travel, transhumanism, post-apocalypse, dystopia, alien invasion, aliens, monsters, mutants, zombies, cyberpunk, steam machine, steampunk, and/or other science fiction themes. The transhumanism theme may include human enhancement and/or other transhumanism themes.

The vehicle theme may include bikes, driving, cars, flight, sailing, submarine, trains, aviation, go-karts, cycling, ships, planes, aircrafts, air balloons, airships, mecha, armored vehicles, tanks, naval crafts, and/or other vehicle themes.

The political theme may include democracy, diplomacy, grand strategy, dictatorship, government, communism, monarchy, and/or other political themes.

The economy theme may include trading, mercantile, stock market, finance, capitalism, money, treasure, gold digging, gambling, industry, and/or other economy themes. The industry theme may include mining, agriculture, and/or other industry themes.

The management theme may include work, city, and/or management themes.

The lifestyle theme may include farm, small town, city, home, fashion, food, beverages, crafts, and/or other lifestyle themes. The city theme may include coffee shop, restaurant, mall, parking lot/garage, grocery store, and/or other city themes. The home theme may include home decoration, gardening, kitchen, domestic chores, and/or other home themes. The fashion theme may include clothes, make up, and/or other fashion themes. The food theme may include candy, fast food, baking, cooking, cakes, drinks, pizza, ice cream, burgers, restaurants, café, bar, and/or other food themes. The beverages theme may include beer, coffee, and/or other beverages themes. The crafts theme may include knitting, scrapbooking, sewing, cross stitch, and/or other crafts themes.

The infrastructure theme may include civil engineering, medical, first responders, and/or other infrastructure themes. The civil engineering theme may include roads, railways, sewage systems, and/or other civil engineering themes. The medical theme may include hospitals, doctors, medicine, pharmacy, and/or other medical themes. The first responders theme may include paramedics, firefighters, police, and/or other first responder themes.

The society theme may include societal issues, belief systems, philosophy, and/or other society themes. The societal issues theme may include evolution, climate change, pandemics, feminism, immigration, minorities, human rights, war, violence, revolution, discrimination, segregation, refugees, bullying, poverty, animal rights, slavery, and/or other societal issues themes. The minorities theme may include indigenous groups and/or other minorities themes. The violence theme may include gangs and/or other violence themes. The belief systems theme may include religion, faith, scripture, religious symbolism, and/or other belief systems themes. The philosophy theme may include logic epistemology, ethics, moral issues, ontology, transhumanism, and/or other philosophy themes.

The health theme may include psychology, cultural environment, sleep, and/or other health themes. The psychology theme may include mental health, identity, mental illness, delusion, deception, illusion, bullying, internal conflict, personal growth, trauma, mind games, and/or other psychology themes. The cultural environment theme may include Africa, North America, South America, Europe, Asian Australia, and/or other cultural environment themes. The sleep theme may include dreams, nightmares, and/or other sleep themes.

The nature theme may include seasons, weather, time-related, animals, plants, natural environments, and/or other nature themes. The seasons theme may include winter, spring, summer, fall, and/or other seasons themes. The weather theme may include rain, sun, overcast, snow, fog, ice, mist, tornado, cyclone, tsunami, clear, smog, and/or other weather themes. The time-related theme may include sunrise, sunset, dusk, dawn, night, day, midday, and/or other time-related themes. The animal theme may include cats, apes/monkeys, bears, birds, cows, dinosaurs, dogs, elephants, foxes, mice, octopuses, owls, pandas, rabbits, racoons, rats, sharks, tigers, whales, wolves, horses, penguins, insects, pets, and/or other animal themes. The plants theme may include flowers, trees, medicinal, succulents, herbs and spice, and/or other plants themes. The natural environments theme may include tropical islands, artic tundra, jungle, mountains, forest, ocean, underwater, underground, air, water, river, stream waterfall, and/or other natural environments themes.

The science theme may include physics, geography, geology, biology, chemistry, mad scientists, evolution, robots, and/or other science themes.

The space theme may include Mars, planets, stars, moon, sun, galaxy, Milky Way, solar system, space exploration, spaceships, universe, and/or other space themes.

The erotic theme may include NSFW, nudity, sexual content, mature adult, and/or other erotic themes.

The art theme may include architecture, indigenous/tribal design, books, library, culture, painting, sculpture, visual arts, museum, music, indie, and/or other art themes. The architecture theme may include Gothic and/or other architecture themes.

The romance theme may include love, flirting, dating, kissing, making out, hugging, LGBTQ+, teen romance, and/or other romance themes.

The relationship theme may include family, friends, coworkers, genealogy, and/or other relationship themes. The genealogy theme may include family tree and/or other genealogy themes.

The comedy theme may include parody, satire, humor, dark comedy, dark humor, and/or other comedy themes.

The animation theme may include cartoon and/or other animation themes.

The anime theme may include Kodomo, Shonen, Shojo, Seinen, Josei, Harem, Reverse Harem, Hentai, Ecchi, Mecha, Lolicon, Shotacon, Isekai, Yaoi or shounen-ai, Yuri or shojo-ai, Slice of Life, and/or other anime themes.

The symbols & abstract theme may include numbers, symbols, words, shapes, and/or other symbols & abstract themes.

The educational theme may include trivia, logic, math, language learning, physics, chemistry, coding, school, and/or other education themes.

The travel theme may include hotels, motels, cruise ships, airplane, train, car/truck, bus, location, landmark, and/or other travel themes. The location theme may include Africa, North America, South America, Europe Asian, Antarctica, Australia, and/or other location themes. The landmark theme may include Eiffel tower, Egyptian pyramids, Big Ben, and/or other landmark themes.

The entertainment theme may include theme parks, rollercoasters, circus, zoo, casino, and/or other entertainment themes.

The media theme may include news, social, movies, music, photography, and/or other media themes. The news theme may include pundits, newspapers, magazines, talk radio, and/or other news themes. The social theme may include Facebook, Twitter, and/or other social themes. The movies theme may include movie theater, movie poster, movie premier, and/or other movie themes. The music theme may include record label, radio, MTV, music video, DJing, singing, genres, and/or other music themes. The singing theme may include singing competition and/or other singing themes. The genres theme may include pop, country, rap/hip-hop, rock, alternative, jazz, classical, world, electronic, folk, oldies, and/or other genres themes. The photography theme may include cameras, selfies, portraits, digital, and/or other photography themes.

The kids theme may include toys and/or other kids themes.

The sports & outdoors theme may include racing, cheerleading, driving, acrobats & circus, yoga & Pilates, archery, weightlifting, cricket, curling, darts, disc golf, dodge ball, field hockey, handball, ice hockey, bowling, boxing, baseball, basketball, volleyball, running, croquet, American football, futbol, biking, lacrosse, roller derby, rugby, skateboarding, wrestling, rodeo, jumping rope, bull riding, ultimate frisbee, fencing, golf, gymnastics, horseback riding, skating, shooting, racquet, water, outdoor, parkour, martial arts, airborne, wheels, fantasy sports, e-sports, and/or other sports & outdoors themes. The volleyball theme may include beach, indoor, and/or other volleyball themes. The biking theme may include road, mountain, and/or other biking themes. The golf theme may include mini golf, Frisbee golf, and/or other golf themes. The horseback riding theme may include dressage, polo, and/or other horseback riding themes. The skating theme may include ice, inline, and/or other skating themes. The shooting theme may include guns, paintball, airsoft, and/or other shooting themes. The racquet theme may include squash, badminton, tennis, and/or other racquet themes. The water theme may include diving, swimming, sailboats, crew, scuba diving, water skiing, snorkeling, surfing, wakeboarding, wind surfing, kite boarding, kayaking, canoe, white water rafting, and/or other water themes. The outdoor theme may include hiking, backpacking, camping, birdwatching, fishing, hunting, mountaineering, rock climbing, skiing, cross-country skiing, snowshoeing, snowboarding, and/or other outdoor themes. The martial arts theme may include karate, aikido, capoeira, Jiu jitsu, judo, kung fu, MMA, Taekwondo, and/or other martial arts themes. The airborne theme may include base jumping, hang gliding, paragliding, skydiving, hot air balloons, and/or other airborne themes. The wheels theme may include go-karts, motocross, snow mobiling, off-roading, rally cars, ATV. four-wheelers, and/or other wheels themes.

The celebrations theme may include birthday, retirement party, graduation, gender reveal, housewarming, anniversary, religious, quinceñera, grand opening, swan song, divorce, bachelor/bachelorette, game day, lunar calendar, TV watch party, white elephant, girls night, boys night, pizza party, ice cream sundae party, pool party, BBQ, field day/flag day, fundraiser, gala event, conference, workshop, and/or other celebrations themes. The religious theme may include Baptism, Bar/Baht mitzvah, and/or other religious themes.

The holidays theme may include Western New Year, Lunar (Chinese) New Year, Winter Solstice, Christmas, Spring Equinox, Summer Solstice, Fall Equinox, Carnival, Mardi Gras, Easter, Holi, Purim, Dragon Boat Festival, Cherry Blossom/Sakura Festival, Rosh Hashanah, Yom Kippur, Thanksgiving, Halloween, All Saints Day, Dia De Los Muertos, Chanukah, Groundhog Day, Black History Month, Women's History Month. Valentine's Day, Presidents Day, Independence Day, Election Day, St. Patrick's Day, Veteran's Day, Cinco de Mayo, Juneteenth, Passover, Father's Day, Mother's Day, Bastille Day, Diwali, Black Friday/Cyber Monday, Kwanzaa, and/or other holidays themes.

The art style and perspective may include visual style, render technique, perspective, and/or other art styles and/or perspectives. The visual style may include abstract, realism, stylized, and/or other visual styles. The abstract visual style may include fractal, psychedelic, simplistic, text, utilitarian, and/or other abstract visual styles. The realism visual style may include hyperrealism, painterly, photorealism, semi realism, and/or other realism visual styles. The stylized visual style may include collage, diorama, exaggerated realism, handicraft, illustrative, map-like, minimalism, silhouette, and/or other stylized visual style. The illustrative visual style may include American comic, anime/manga, caricature, cartoonish, engraving, hand painted, LEGO, watercolor, and/or other illustrative visual styles. The cartoonish visual style may include edgy, fat round, flat, and/or other cartoonish visual style.

The render technique may include 2D cutout, block 3D, full motion video, rasterized, ray traced, cell-shaded, low-poly, pixel art, procedurally-generated, rotoscoped, wireframe, and/or other render techniques. The pixel art render technique may include 8 bit, 16 bit, and/or other techniques.

The perspective may include aerial, bird view, first person, side view, text, third person, virtual reality, 2D, 3D, augmented reality, combo of 2D and 3D, virtual reality, and/or other perspectives.

The brand intellectual property may include sports, soccer (football), football, baseball, hockey, pool, poker, basketball, rugby, fighting, tennis, golf, racing, bowling, movies, action, adult, adventure, animation, biography, comedy, crime/gangster, documentary, drama, education, family, fantasy, film noir, history, horror, music, musical, mystery, romance, sci-fi, sport, superhero, thriller, war, western, TV shows, game show, history, horror, music, musical, mystery, news, reality-tv, talk show, comic/novel, alternative/esoteric, celebrity, business, entrepreneurship, social media (internet), music, film, tv, writing (books), journalism, science, esports, consumer product/toys/other, beauty, hygiene, fashion, outdoor, gaming, technology, TV/entertainment, AR/VT, household, kids toys, candy, and/or other brand intellectual properties.

The modes may include player-as-manager, cooperative, non-cooperative, single player, multi-player, competitive, time attack, player-as-actor, no actor, sandbox, player-vs-environment, and/or other modes.

The churn may include deliberate, incidental, and/or other churns. The deliberate churn may include technology, finances, onboarding, gameplay, social, psychological, advertising, trust, competition, and/or other deliberate churns. The finance churn may include paywall, pay to win, low return on investment, and/or other finance churns. The onboarding churn may include too complex in the beginning, too simple in the beginning, too long intro, too long tutorial, unclear tutorial, scripted win, and/or other onboarding churns. The unclear tutorial churn may include unclear tutorial content, too much text, too much information at once, and/or other unclear tutorial churns. The unclear tutorial content churn may include unclear presentation, unclear text, and/or other unclear tutorial churns. The gameplay churn may include sudden escalation in difficulty, lack of interesting content, all content consumed, lack of updates, too frequent updates, too much repetition, too much grinding, wrong platform, too similar to prior games, too long sessions no engaging short session loop, lack of sense, scarce resources, too big time investment to progress in game, lack of feedback, lack of progress indication, punishments for inactivity, unappealing aesthetics, does not spark emotion, unintuitive UI, and/or other gameplay churns. The sudden escalation in difficulty churn may include sudden escalation in level difficulty, sudden escalation in task difficulty, sudden escalation in opponent difficulty, and/or other sudden escalation in difficulty churns. The lack of interesting content churn may include lack of interesting items, lack of interesting characters, lack of interesting levels, and/or other lack of interesting content churns. The lack of updates churn may include lack of season content, lack of events, and/or other lack of updates churns. The too frequent updates churn may include too frequent changes to core gameplay, too big changes to core gameplay, and/or other too frequent updates churns. The lack of sense churn may include no meaningful challenges and/or other lack of sense churns. The scarce resources churn may include too scarce resources in early game, too scarce resources in late game, and/or other scarce resources churns. The unappealing aesthetics churn may include unappealing visuals, unappealing soundscape, and/or other unappealing aesthetics churns. The unintuitive UI churn may include unclear UI elements and/or other unintuitive UI churns. The social churn may include friends stopped playing, no friends in game, no meaningful community, no critical mass, toxic community, toxic players, socially inappropriate, not “cool”, lack of in-game communication tools, lack of multiplayer, unbalanced battle matching, and/or other social churns. The toxic players churn may include ineffective reporting, lack of reporting possibility, and/or other toxic players churns. The unbalanced battle matching churn may include unbalances PVP matching, unbalanced team matching, and/or other unbalanced battle matching churns. The psychological churn may include too competitive, too stressful, and/or other psychological churns. The advertising churn may include too frequent ads, irrelevant ads, distracting from gameplay, interrupting gameplay, and/or other advertising churns. The trust churn may include lack of trust in data privacy, lack of trust in transaction, and/or other trust churns. The competition churn may include better option available and/or other competition churn.

The incidental churn may include finances, major life change, change of platform, and/or other incidental churns. The finances churn may include lack of funds to progress in game, lack of funds to pay for subscription, and/or other finances churns.

The marketing assets may include outcome, channel, asset types, placements, concepts, emotional drivers, real world topics, creative content, film, interactive content, explainer, call to action, and/or other marketing assets.

The outcome asset may include product objectives, awareness, consideration, conversion, and/or other outcome assets. The product objectives asset may include cross-promotion, new product, test product, and/or other product objectives assets. The awareness asset may include brand awareness, reach, and/or other awareness assets. The consideration asset may include traffic, engagement, app installs, video views, lead generation, messages, and/or other consideration assets. The conversion asset may include conversions, sales, store traffic, and/or other conversion assets.

The channel asset may include online, offline, and/or other channel assets. The online asset may include social media and/or other online assets. The social media asset may include placement, networks, and/or other social media assets. The placement asset may include news feed, story, app store, and/or other placement assets. The networks asset may include Facebook, Snapchat, Google, Tiktok, and/or other networks assets. The offline asset may include placement and/or other offline assets. The placement asset may include billboard, banner, and/or other placement assets.

The asset types may include image (static), image (animated), video, interactive, playable, native (integrated), and/or other asset types.

The placements asset may include feeds, story, in-stream, search, messages, in-article, apps, YouTube, and/or other placements assets. The feeds asset may include Facebook news feed, Instagram feed, Facebook marketplace, Facebook video feeds, Facebook right column, Instagram Explore, Messenger Inbox, and/or other feeds assets. The story asset may include Facebook stories, Instagram stories, Messenger stories, and/or other story assets. The in-stream asset may include Facebook in-stream videos and/or other in-stream assets. The search asset may include Facebook search results and/or other search assets. The messages asset may include Messenger sponsored messages and/or other messages assets. The in-article asset may include Facebook instant articles and/or other in-article assets. The apps asset may include audience network native, banner, interstitial, audience network rewarded videos, and/or other apps assets.

The concepts assets may include choice based, results based, mini-game, humorous voiceover, benefit focused, story-based, and/or other concepts assets. The choice-based asset may include wrong choice, choose your adventure, and/or other choice-based assets. The results-based asset may include fail ad, win ad, fail (then win), big decision, countdown, and/or other results-based assets. The mini-game asset may include puzzle, hidden items/objects, design challenge, connect the dots, color by numbers, matching cards, competition, and/or other mini-game assets. The benefit focused asset may include train your brain, relax/calm, scientific claim, creativity, enhance memory, and/or other benefit focused assets. The story-based asset may include free/save a character, locks & gates, noob vs. pro, character backstory, skill improvement, rescue, tragedy, unsolved mystery, and/or other story-based assets.

The emotional drivers asset may include excitement, social connection, expertise, success, escape, creativity, and/or other emotional drivers assets. The excitement asset may include discovery, war/fight, event, leaderboard, and/or other excitement assets. The social connection asset may include community, clan, PVP, competition, and/or other social connection assets. The expertise asset may include advanced battle, scenarios, formations, multiple combos, and/or other expertise assets. The success asset may include clearing stages, leveling up, winning, failing, and/or other success assets. The escape asset may include immersion, escaping, and/or other escape assets. The creativity asset may include avatars, customization, experiment, and/or other creativity assets.

The real-world topics asset may include social responsibility, environmental issues, current events, and/or other real world topics assets. The social responsibility asset may include data privacy, diversity, inclusivity, accessibility, gender identity, and/or other social responsibility assets. The environmental issues asset may include eco-friendly, sustainability, and/or other environment issues assets. The current events asset may include real news, fake news, parody, satire, and/or other current events assets.

The creative content asset may include gameplay, feature focused, collaboration, IP focused, and/or other creative content assets. The gameplay asset may include game overview, real gameplay, social play/community, solo play, and/or other gameplay assets. The feature focused asset may include collectables, donating, and/or other feature focused assets. The collaboration asset may include brand collaboration, influencer, celebrity spokesperson, interview/testimonial, aspirational/optimistic story, and/or other collaboration assets. The influencer asset may include micro influencer, premier influencer, contest, giveaway, and/or other influencer assets. The IP focused asset may include character, logo, and/or other IP focused assets. The character asset may include fictional character, real character, and/or other character assets.

The film asset may include real life reenactment, trailer, music video, and/or other film assets.

The interactive content asset may include quiz, playable game, and/or other interactive content assets.

The call-to-action asset may include rewarded, sharable, activation code, special offer, informational, and/or other call to action assets.

The creative elements may include coin, flag, light bulb, toy, home appliance, plumbing fixture, office supplies, paper towel, pillow, kitchenware, fireplace, countertop, book, furniture, dog bed, cat furniture, lantern, clock, vase, window blind, curtain, mirror, sculpture, picture frame, candle, lamp, bathroom accessory, beehive, tent, parking meter, traffic light, billboard, traffic sign, fire hydrant, fountain, street light, jacuzzi, building, swimming pool, person, food, plant, vehicle, clothing, animal, cosmetics, personal care, medical equipment, musical instrument, sports equipment, tool, weapon, cassette deck, headphones, laptop, computer keyboard, printer, computer mouse, computer monitor, AC power plugs and socket-outlets, light switch, television, telephone, tablet computer, microphone, iPod, remote control, drink, bicycle wheel, door handle, door, window, stairs, porch, human eye, skull, head, human face, human mouth, human ear, human head, hair, human hand, human foot, human arm, human leg, human beard, body part, auto part, coconut, and/or other creative elements.

The toy element may include doll, balloon, dice, flying disc, kite, teddy bear, and/or other toy elements.

The home appliance element may include washing machine, toaster, oven, blender, gas stove, mechanical fan, heater, kettle, hair dryer, refrigerator, wood-burning stove, humidifier, mixer, coffeemaker, microwave oven, dishwasher, sewing machine, hand dryer, ceiling fan, and/or other home appliance elements.

The plumbing fixture element may include sink, bidet, shower, tap, bathtub, toilet, and/or other plumbing fixture elements.

The office supplies element may include scissors, poster, calculator, box, stapler, whiteboard, pencil sharpener, eraser, fax, adhesive tape, ring binder, pencil case, plastic bag, paper cutter, toilet paper, envelope, pen, and/or other office supplies elements.

The kitchenware element may include kitchen utensils, tableware, frying pan, wok, spice rack, kitchen appliance, and/or other kitchenware elements. The kitchen utensil element may include chopsticks, ladle, spatula, can opener, cutting board, whisk, drinking straw, knife, bottle opener, measuring cup, pizza cutter, spoon, fork, and/or other kitchen utensil elements. The tableware element may include chopsticks, teapot, mug, coffee cup, salt and pepper shakers, mixing bowl, saucer, cocktail shaker, bottle, bowl, plate, pitcher, kitchen knife, jug, platter, wine glass, spoon, fork, serving tray, cake stand, and/or other tableware elements. The kitchen appliance element may include oven, blender, slow cooker, food processor, refrigerator, waffle iron, mixer, coffeemaker, microwave oven, pressure cooker, dishwasher, and/or other kitchen appliance elements.

The furniture element may include chair, cabinetry, desk, wine rack, couch, wardrobe, nightstand, bookcase, bed, filing cabinet, table, chest of drawers, cupboard, bench, drawer, stool, shelf, wall clock, bathroom cabinet, closet, and/or other furniture elements. The couch element may include sofa bed, loveseat, and/or other couch elements. The bed element may include infant bed, studio couch, and/or other bed elements. The table element may include coffee table, kitchen & dining room table, and/or other table elements.

The clock element may include alarm clock, digital clock, wall clock, and/or other clock elements.

The sculpture element may include snowman, bust, bronze sculpture, and/or other sculpture elements.

The bathroom accessory element may include towel, toilet paper, soap dispenser, facial tissue holder, and/or other bathroom accessory elements.

The traffic sign element may include stop sign and/or other traffic sign elements.

The building element may include tree house, lighthouse, skyscraper, castle, tower, house, office building, convenience store, medical equipment, musical instrument, sports equipment, tool, weapon, cassette deck, headphones, laptop, computer keyboard, printer, computer mouse, computer monitor, ac power plugs and socket-outlets, light switch, musical keyboard, television, telephone, tablet computer, microphone, iPod, remote control and/or other building elements. The medical equipment element may include syringe, stretcher, stethoscope, band-aid, and/or other medical equipment elements. The musical instrument element may include organ, banjo, cello, drum, horn, guitar, harp, harpsichord, harmonica, musical keyboard, oboe, piano, saxophone, trombone, trumpet, violin, chime, flute, accordion, maracas, and/or other musical instrument elements. The sports equipment element may include paddle, ball, bicycle, surfboard, bow and arrow, hiking equipment, roller skates, flying disc, baseball bat, baseball glove, punching bag, golf ball, lifejacket, scoreboard, snowboard, skateboard, ski, bowling equipment, dumbbell, stationary bicycle, treadmill, training bench, indoor rower, horizontal bar, parachute, racket, balance beam, helmet, billiard table, and/or other sports equipment elements. The ball element may include football, cricket ball, volleyball, tennis ball, rugby ball, and/or other ball elements. The bicycle element may include bicycle wheel and/or other bicycle elements. The racket element may include tennis racket, table tennis racket, and/or other racket elements. The helmet element may include bicycle helmet, football helmet, and/or other helmet elements. The tools element may include container, ladder, toothbrush, screwdriver, drill, chainsaw, wrench, flashlight, scissors, ratchet, the kitchen utensil, hammer, scale, snowplow, nail, tripod, torch, chisel, axe, camera, grinder, ruler, binoculars, and/or other tool elements. The container element may include tin can, barrel, bottle, picnic basket, jug, waste container, beaker, flowerpot, and/or other container element. The weapons element may include the bow and arrow, cannon, dagger, knife, rifle, shotgun, tank, axe, handgun, sword, missile, bomb, and/or other weapons elements. The telephone element may include mobile phone, corded phone, and/or other telephone elements.

The person element may include man, women, boy, girl, body part, and/or other person elements. The body part element may include human eye, skull, head, human face, human mouth, human ear, human head, hair, human hand, human foot, human arm, human leg, human beard, and/or other body part elements.

The food element may include fast food, waffle, pancake, burrito, snack, dessert, guacamole, fruit, egg, baked goods, mushroom, pasta, pizza, seafood, taco, cooking spray, vegetable, honeycomb, sandwich, dairy, sushi, and/or other food elements. The fast-food element may include hot dog, French fries, and/or other fast-food elements. The snack element may include pretzel, popcorn, cookie, and/or other snack elements. The dessert element may include muffin, cookie, ice cream, cake, candy, and/or other dessert elements. The fruit element may include apple, grape, common fig, pear, strawberry, tomato, lemon, banana, orange, peach, mango, pineapple, grapefruit, pomegranate, watermelon, cantaloupe, and/or other fruit elements. The baked goods element may include pretzel, bagel, muffin, cookie, bread, pastry, and/or other baked goods elements. The pastry element may include doughnut, croissant, tart, and/or other pastry elements. The seafood element may include squid, shellfish, and/or other seafood elements. The shellfish element may include oyster, lobster, shrimp, crab, and/or other shellfish elements. The vegetable element may include cucumber, radish, artichoke, potato, tomato, asparagus, squash, cabbage, carrot, salad, broccoli, bell pepper, winter melon, and/or other vegetable elements. The squash element may include pumpkin, zucchini, and/or other squash elements. The sandwich element may include hamburger, submarine sandwich, and/or other sandwich elements. The dairy element may include cheese, milk, and/or other dairy elements.

The plant elements may include houseplant, tree, flower, and/or other plant elements. The tree element may include Christmas tree, palm tree, maple, willow, and/or other tree elements. The flower element may include lavender, rose, sunflower, lily, and/or other flower elements.

The vehicle element may include land vehicle, watercraft, aerial vehicle, and/or other vehicle elements. The land vehicle element may include ambulance, cart, bicycle, bus, snowmobile, golf cart, motorcycle, Segway, tank, train, truck, unicycle, car, taxi, wheelchair, auto part, and/or other land vehicle elements. The bicycle element may include bicycle wheel and/or other bicycle elements. The car element may include limousine, van, and/or other car elements. The auto part element may include vehicle registration plate, wheel, seat belt, tire, and/or other auto part elements. The watercraft element may include boat, jet ski, submarine, and/or other watercraft elements. The boat element may include barge, gondola, canoe, and/or other boat elements. The aerial vehicle element may include helicopter, airplane, rocket, and/or other aerial vehicle.

The clothing element may include shorts, dress, swimwear, brassiere, tiara, shirt, coat, suit, hat, scarf, skirt, jacket, fashion accessory, swim cap, trousers, footwear, sports uniform, luggage & bags, helmet, and/or other clothing elements. The hat element may include cowboy hat, fedora, sombrero, sun hat, and/or other hat elements. The skirt element may include miniskirt and/or other skirt elements. The fashion accessory element may include glove, belt, sunglasses, tiara, necklace, sock, earrings, tie, goggles, the hat, scarf, handbag, watch, umbrella, glasses, crown, and/or other fashion accessory elements. The glove element may include baseball glove and/or other glove elements. The trousers element may include jeans and/or other trouser elements. The footwear element may include roller skates, boots, high heels, sandals, and/or other footwear elements. The luggage & bags element may include backpack, suitcase, briefcase, handbag, and/or other luggage & bag elements.

The animal element may include bird, invertebrate, mammal, reptile & amphibian, fish, the shellfish, and/or other animal elements. The bird element may include magpie, woodpecker, blue jay, ostrich, penguin, raven, chicken, eagle, owl, duck, canary, goose, swan, falcon, parrot, sparrow, turkey, and/or other bird elements. The invertebrate element may include tick, centipede, marine invertebrates, insect, scorpion, worm, spider, oyster, snail, and/or other invertebrate elements. The marine invertebrates element may include starfish, isopod, squid, lobster, jellyfish, shrimp, crab, and/or other marine invertebrates elements. The insect element may include bee, beetle, ant, moths & butterflies, dragonfly, and/or other insect elements. The beetle element may include ladybug and/or other beetle elements. The moths & butterflies element may include caterpillar, butterfly, and/or other moth & butterflies elements. The mammal element may include bat, carnivore, camel, cattle, giraffe, rhinoceros, goat, horse, hamster, kangaroo, koala, mouse, pig, rabbit, squirrel, sheep, zebra, monkey, hippopotamus, deer, elephant, porcupine, hedgehog, bull, antelope, mule, marine mammal, skunk, alpaca, armadillo, and/or other mammal elements. The carnivore element may include bear, cat, fox, jaguar, lynx, red panda, tiger, lion, dog, leopard, cheetah, otter, racoon, and/or other carnivore elements. The bear element may include brown bear, panda, polar bear, teddy bear, and/or other bear elements. The marine mammal element may include dolphin, whale, sea lion, harbor seal, and/or other marine mammal elements. The reptile & amphibian element may include dinosaur, lizard, snake, turtle, crocodile, frog, and/or other reptile & amphibian elements. The turtle element may include tortoise, sea turtle, and/or other turtle elements. The fish element may include goldfish, shark, rays and sharks, seahorse, and/or other fish elements.

The cosmetic element may include face powder, hair spray, lipstick, perfume, and/or other cosmetic elements.

The personal care element may include toothbrush, sunglasses, goggles, crutch, cream, diaper, glasses wheelchair, and/or other personal care elements.

The medical equipment element may include syringe, stretcher, stethoscope, band-aid, and/or other medical equipment elements.

The musical instrument element may include organ, banjo, cello, drum, horn, guitar, harp, harpsichord, harmonica, musical keyboard, oboe, piano, saxophone, trombone, trumpet, violin, chime, flute, accordion, maracas, and/or other musical instrument elements.

The sports equipment element may include paddle, ball, bicycle, surfboard, bow and arrow, hiking equipment, roller skates, flying disc, baseball bat, baseball glove, punching bag, golf ball, lifejacket, scoreboard, snowboard, skateboard, ski, bowling equipment, dumbbell, stationary bicycle, treadmill, training bench, indoor rower, horizontal bar, parachute, racket, balance beam, helmet, billiard table, and/or other sports equipment elements.

The tools element may include the container, ladder, toothbrush, screwdriver, drill, chainsaw, wrench, flashlight, scissors, ratchet, the kitchen utensil, hammer, scale, snowplow, nail, tripod, torch, chisel, axe, camera, grinder, ruler, binoculars, and/or other tool elements.

The drink element may include beer cocktail, coffee, juice, tea, wine, and/or other drink elements.

The door element may include door handle and/or other door elements.

The auto part element may include vehicle registration plate, wheel, seat belt, tire.

The content parameter values may be a number within a defined range (e.g., 1-10), a binary number, a letter score, a yes or no, and/or other type of value. In some implementations, the content parameter values being within a particular range may signify that multiple ones of the content parameter values are similar. For example, the content parameter values for a first content parameter may be a number within a defined range of 0-20. The content parameter values of 1-5 may be considered similar content parameter values for the first content parameter.

The psychological profiles may be based on or derived from stated information and/or other information. The psychological profiles may include psychological parameter values for psychological parameters. The stated information may include answers of the users to questions presented to the users, descriptions provided by the users that describe their psychological traits and/or themselves generally, one or more pieces of content (e.g., music genre, color palette, television shows, etc.) the users like or have an affinity to, one or more pieces of content the users dislike or have an aversion to, and/or other stated information that the users may provide regarding themselves. The questions may be related to psychological attributes, real-world interactions, real-world likes and dislikes, and/or other questions.

The psychological profile for the given subject may include psychological parameter values to psychological parameters derived from the stated information for the given subject, and/or other information. Similarly, psychological profiles for the individual subjects may include sets of psychological parameter values to the psychological parameters for the individual subjects. The psychological parameters may include the psychological parameters as listed in co-pending U.S. application Ser. No. 16/854,660 entitled “SYSTEMS AND METHODS FOR ADAPTING USER EXPERIENCE IN A DIGITAL EXPERIENCE BASED ON PSYCHOLOGICAL ATTRIBUTES OF INDIVIDUAL USERS”, Attorney Docket No. 01TT-064001, the disclosure of which is incorporated by reference in its entirety herein. The psychological profiles may be associated with and/or generated in relation with digital environments such as particular online games, online platforms, online applications, and/or other digital environments as described in in co-pending U.S. application Ser. No. 17/545,866 entitled “SYSTEMS AND METHODS TO FACILITATE MANAGEMENT OF ONLINE SUBJECT INFORMATION”, Attorney Docket No. 01TT-064015, the disclosure of which is incorporated by reference in its entirety herein.

Parameters, such as content parameters and psychological parameters are described herein, may specify measurable, recordable, and/or determined information. The parameter values corresponding to the parameters may be a particular value, numerical or non-numerical, that characterizes the content, the users, or respective element that the parameter value is described in relation to.

The interaction information may characterize interactions between users and the pieces of content via the digital environments and/or engagement by the users with the pieces of content. By way of non-limiting example, the interaction information may include timing information, expense information, movement information related to the interactions with the content, behavior patterns of the user with or based on the pieces of content, and/or other interaction information.

The behavior patterns of the individual users may include individual actions, sets of actions, ordered sets of actions, time spent by the individual users engaging with the content and/or the online platforms, spending patterns of the users characterized by the expense information, completed tasks by the individual users by utilizing the pieces of content, uncompletion tasks by the individual users based on lack of utilizing the pieces of content, failure of tasks by the individual users due to the pieces of content, and/or other behavior patterns. In some implementations, the behavior patterns may include multiple of the individual actions, the sets of actions, and the ordered set of actions. The actions may include one or more of a purchase, a sale, a trade, a donation, a user selection (e.g., to open, close, hide, terminate, delay, etc.), gameplay (e.g., mini-game, battle, competition, etc.), communication of the individual users with other particular users, frequent interaction with the content, formation of alliances by the users, and/or other actions with, of, or based on the pieces of content.

The timing information may include values to length of time the users interacted with the individual pieces of content, how often the users interacted with the individual pieces of content in different instances, a start date/time at which the pieces of content are interacted with by the users, an end date/time at which the users stop interacting with the pieces of content after the start date/time, and/or other timing information. The expense information may include values to an amount spent during an interaction, an amount earned from sales (e.g., of during the interaction), an amount donated in relation to the pieces of content, an increase in valuation of a piece of content based on the interaction, a decrease in valuation of the piece of content based on the interaction, and/or other expense information. The movement information related to the interactions with the content may include values to orientation (e.g., yaw angle, roll angle, pitch angle) of the pieces of content upon the interaction, displacement of the pieces of content upon the interaction, kicking of the pieces of content, bouncing of the pieces of content, grabbing of the pieces of content, spinning of the pieces of content, and/or other movement information.

In some implementations, the interaction information may include or indicate whether the users have affinities for the individual pieces of content or aversions to the individual pieces of content. For example, given the timing information indicating that a first user frequently interacts with a first object (i.e., a piece of content) and for long length of time, the interaction information may indicate that the first user has an affinity to the first object. As another example, upon the behavior patterns of the first user including frequent selection to close or otherwise ignore a second piece of content, the interaction information may indicate that the first user has an aversion to the second piece of content and/or pieces of content with the same or similar content parameter values to the content parameters.

Content definition receiving component 110 may be configured to receive a content definition for prospective content. The prospective content may be content that a requesting user of system 100 is requesting an audience of users for. The requesting user may include an online platform developer such a single user, a company, and/or other requesting user. For example, the prospective content may be a game, a game mechanic, an advertisement (e.g., an image, a video), an online platform (e.g., social media platform, a work management platform, a communication platform), a class (e.g., fitness class, an educational class, etc.), a philanthropic organization, a category of philanthropy (e.g., environmental, homelessness, animals, etc.), an image for consumption (e.g., purchase, download, sharing), a video for consumption, a non-fungible token, and/or other prospective content. The content definition may be received via client computing platform 104. The content definition may include particular values that define, characterize, or are similar to the prospective content. For example, the content definition may include values to specify the game, a television show, a movie, a brand, an interest, an activity, the game mechanic, a brand, an art style, an application, an application feature, a theme, a subscription, and/or other characteristics that define, characterize, or are similar to the prospective content.

In some implementations, content definition receiving component 110 may be configured to determine the one or more of the taxonomical classifications for the prospective content, i.e., one or more content parameter values to one or more of the content parameters based on the content definition. In some implementations, the content definition received may include a representation of the prospective content such as an image of the prospective content, a video of the prospective content (e.g., a game demonstration, a television show episode, etc.), a description of the prospective content, a name of the prospective content (e.g., name of an organization), and/or other representation of the prospective content. In some implementations, content definition receiving component 110 may be configured to analyze the representation of the prospective content to determine the one or more of the taxonomical classifications for the prospective content. Analyzing the representation of the prospective content may be via image analysis software, video analysis software, machine learning, and/or other analysis techniques. The determined one or more content parameter values to one or more content parameters may be subsequently included in the content definition.

In some implementations, the content definition may include content parameter values to a set of the content parameters for the prospective content. That is, the content definition may specify one or more of the taxonomical classifications for the prospective content. In some implementations, presentation effectuation component 116 may be configured to effectuate presentation of the content parameters of the taxonomy via client computing platform 104 associated with the requesting user. Such presentation may enable the requesting user to provide the content parameter values for one or more of the content parameters that characterize the prospective content, i.e., the content definition. In some implementations, the requesting user may prioritize one or more of the content parameters to indicate the taxonomical classifications that are the most prevalent to less prevalent.

Content identifying component 112 may be configured to identify a set of the pieces of content based on similarity between the taxonomical classifications of the individual pieces of content, the taxonomical classification of the prospective content as indicated by the content definition, and/or other information. Meaning, the taxonomical classifications of the pieces of content may be analyzed against the taxonomical classifications of the prospective content to determine if the taxonomical classifications are similar. Determination of whether the taxonomical classifications are similar may include determining a defined amount of the content parameter values to the content parameters that are identical, whether a majority of the content parameter values to the content parameters are similar (e.g., within individual similar ranges), whether the content parameter values to the content parameters based on the prioritization of the content parameters are similar, machine learning for similarity determination techniques, and/or other determinations of similarity. The defined amount of the content parameter values to the content parameters that are identical may be specified by an administrative user of system 100, may be a fixed amount, percentage, and/or portion, may be modifiable by the administrative user, and/or other defined amount.

Correlation component 114 may be configured to correlate one or more combinations of psychological parameter values with the prospective content based on i) the interaction information for the set of pieces of content, ii) the psychological parameter values included in the psychological profiles of the users that interacted with the set of pieces of content, and/or other information. Correlating the one or more combinations of psychological parameter values with the prospective content may be based on the affinities and/or the aversions, as indicated by the interaction information, of the users that interacted with the set of the pieces of content, and/or other information. Correlation techniques to correlate the one or more combinations of psychological parameter values with the prospective content may be contemplated. The correlations may convey the one or more combinations of the psychological parameter values for users that have affinities and/or aversions for the set of the pieces of content. It will be appreciated that the description herein of “correlations” between combinations of the psychological parameters and the prospective content which are positively correlated is not intended to be limiting, and that negative correlations between combinations of the psychological parameters and the prospective content are also contemplated, and may be included in the generic “correlations”. The determination of negative correlations may be made in cases where users strongly presenting a psychological parameter avoid the pieces of content similar to the prospective content, and/or where users that do not present the psychological parameter have an affinity to content that is classified as the opposed of the prospective content than users that strongly present the psychological parameter.

Prospective user identifying component 118 may be configured to identify a set of prospective users for the prospective content based on the correlated one or more combinations of psychological parameter values and the psychological profiles of the users. That is, from the psychological profiles stored in electronic storage 122, the set of prospective users and their corresponding psychological profiles may be identified based on the one or more combinations of psychological parameter values included in the correlations. Thus, the set of prospective users may be the target audience for the prospective content. In some implementations, identifying the set of prospective users for the prospective content may be performed by determining the psychological profiles with commonalities between the psychological parameter values and the one or more combinations of psychological parameter values. In some implementations, the commonalities may be that all of the psychological parameter values are identical between the combinations and the psychological profiles, that a majority of the psychological parameter values are identical, that all the psychological parameter values to the psychological parameters are with a particular range of each other (e.g., +/−2 points), that a majority of the psychological parameter values to the psychological parameters are with the particular range of each other, and/or other indications of commonality. The various information determined, identified, and/or received as described herein may be stored to electronic storage 122 and/or other storage media in communication with system 100.

Presentation effectuation component 116 may be configured to effectuate, via client computing platform 104, presentation of the psychological parameter values for the psychological parameters of the set of the prospective users. In some implementations, the set of prospective users may be presented such that the requesting user may provide the set of the prospective users with the prospective content via client computing platform 104. Thus, the prospective content may be pushed to the set of the prospective users via their respective digital environments they interact with.

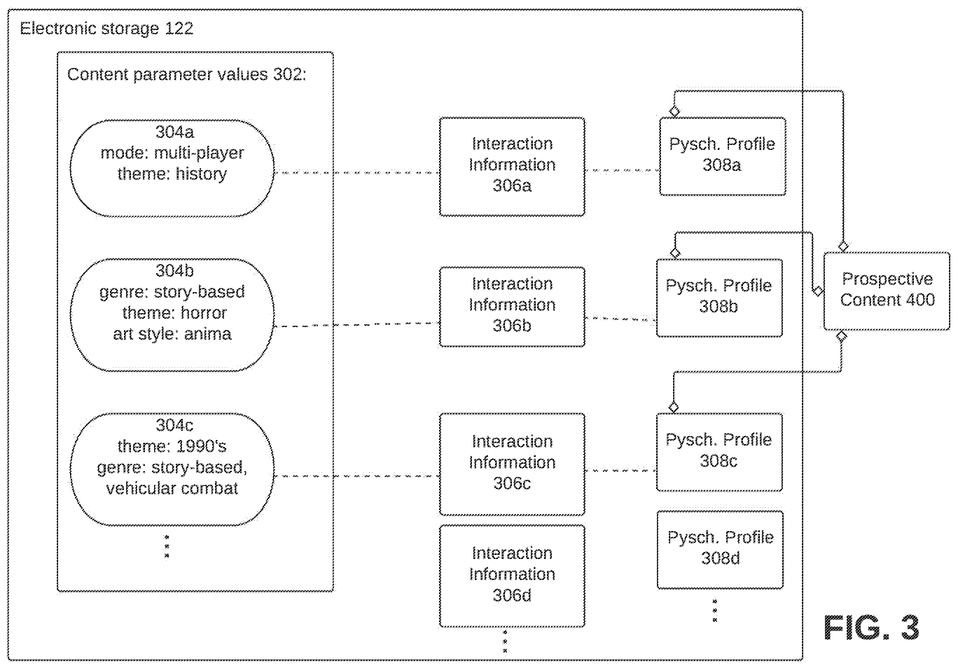

FIG. 3 illustrates electronic storage 122 the same as or similar as in FIG. 1. Electronic storage 122 may store content parameter values 302 for content 304a, 304b, and 304c. Electronic storage 122 may further store interaction information 306a, 306b, 306c, and 306d of the users who have interacted with the content that have content parameter values 302, where stored interaction information 306a-c correspond to content 304a-c, respectively. Electronic storage 122 may further store psychological profiles 308a, 308b, 308c, and 308d. Interaction information 306a-c may characterize how users associated with psychological profiles 308a-c, respectively, interacted with content 304a, 304b, and 304c, respectively.

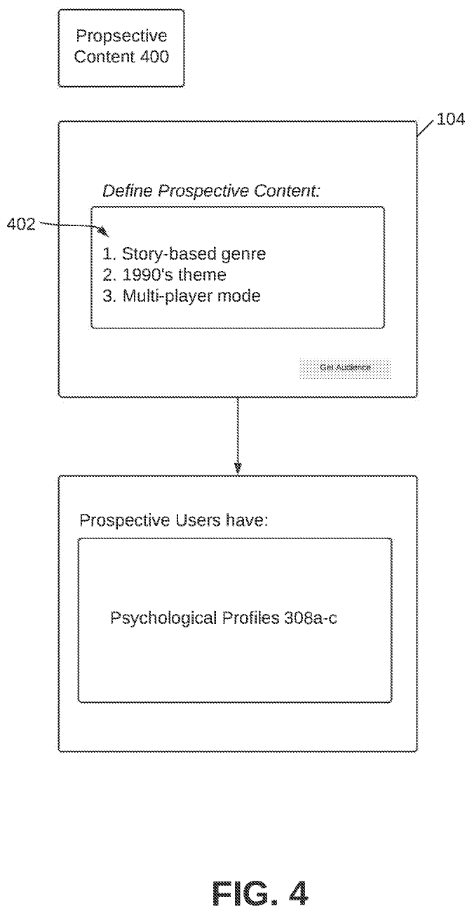

FIG. 4 illustrates a requesting user utilizing system 100 (of FIG. 1) to determine a target audience for prospective content 400. Prospective content 400 may be characterized by content definition 402 input by the requesting user via client computing platform 104. Based on similarities between the taxonomical classifications as defined by content definition 402 and the taxonomical classifications as defined by content parameter values 302 of the content in FIG. 3, content 304a-c may be identified.

Referring to FIG. 3, one or more combinations of psychological parameter values to psychological parameters as defined in psychological profiles 308a-c of the users that interacted with identified content 304a-c may be correlated with prospective content 400 (the same as or similar as in FIG. 4). Such correlations may be stored to electronics storage 122 and/or other storage. Thus, particular users that may have an affinity for prospective content 400 may be identified based on the correlations of prospective content 400 with the one or more combinations of psychological parameter values. The particular users may be presented and/or their psychological profiles 308a-c via client computing platform 104 in FIG. 4. As such, the requesting user may be provided with the target audience for their prospective content 400 and be enabled to efficiently present prospective content 400 to users who may consume and like such.

Referring back to FIG. 1, in some implementations, server(s) 102, client computing platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 120 may be operatively linked via some other communication media.

A given client computing platform 104 may include one or more processors configured to execute computer program components. The computer program components may be configured to enable an expert or user associated with the given client computing platform 104 to interface with system 100 and/or external resources 120, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables server(s) 102 to function as described herein.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute components 110, 112, 114, 116, and/or 118, and/or other components. Processor(s) 124 may be configured to execute components 110, 112, 114, 116, and/or 118, and/or other components by software; hardware; firmware; some combination of software, hardware, and/or firmware; and/or other mechanisms for configuring processing capabilities on processor(s) 124. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 110, 112, 114, 116, and/or 118 are illustrated in FIG. 1 as being implemented within a single processing unit, in implementations in which processor(s) 124 includes multiple processing units, one or more of components 110, 112, 114, 116, and/or 118 may be implemented remotely from the other components. The description of the functionality provided by the different components 110, 112, 114, 116, and/or 118 described below is for illustrative purposes, and is not intended to be limiting, as any of components 110, 112, 114, 116, and/or 118 may provide more or less functionality than is described. For example, one or more of components 110, 112, 114, 116, and/or 118 may be eliminated, and some or all of its functionality may be provided by other ones of components 110, 112, 114, 116, and/or 118. As another example, processor(s) 124 may be configured to execute one or more additional components that may perform some or all of the functionality attributed below to one of components 110, 112, 114, 116, and/or 118.

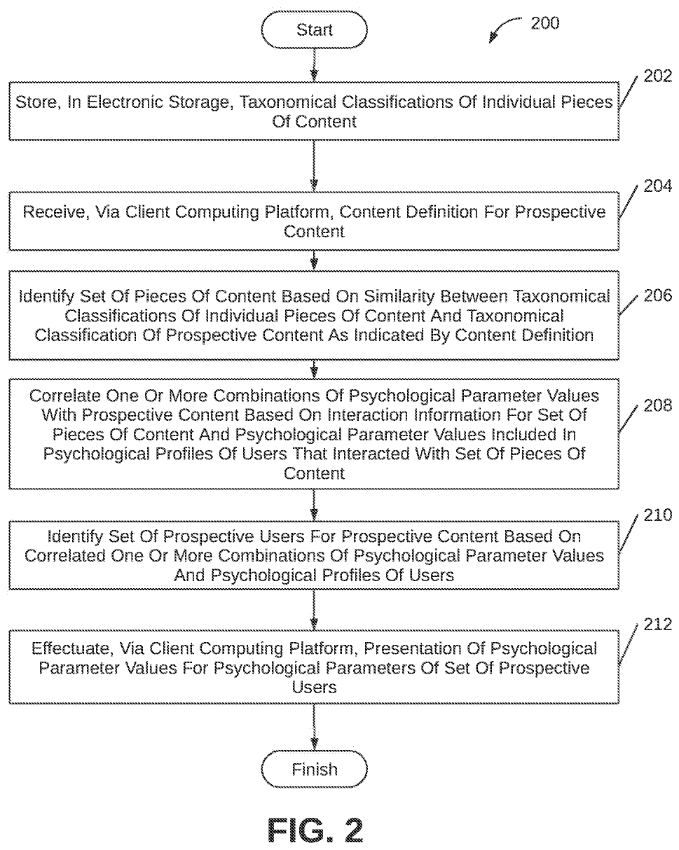

FIG. 2 illustrates a method 200 to identify a target audience for prospective content based on a taxonomy, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include storing, in electronic storage, taxonomical classifications of individual pieces of content. Individual taxonomical classifications may include content parameter values for content parameters that define classifications for the individual pieces of content, psychological profiles for users of digital environments, and iii interaction information that characterizes interactions between users and the pieces of content via the digital environments. The taxonomical classifications may conform to a taxonomy that defines a hierarchical system of the content parameters that facilitate providing the pieces of content with the classifications. The pieces of content may be defined by the content parameter values for some or all of the content parameters. The psychological profiles may include psychological parameter values for psychological parameters. Operation 202 may be performed by a component that is the same as or similar to electronic storage 122, in accordance with one or more implementations.

An operation 204 may include receiving, via a client computing platform, a content definition for prospective content. The content definition may include content parameter values to a set of the content parameters for the prospective content. Operation 204 may be performed by one or more hardware processors configured by machine-readable instructions including a component that is the same as or similar to content definition receiving component 110, in accordance with one or more implementations.

An operation 206 may include identifying a set of the pieces of content based on similarity between the taxonomical classifications of the individual pieces of content and the taxonomical classification of the prospective content as indicated by the content definition. Operation 206 may be performed by one or more hardware processors configured by machine-readable instructions including a component that is the same as or similar to content identifying component 112, in accordance with one or more implementations.

An operation 208 may include correlating one or more combinations of psychological parameter values with the prospective content based on the interaction information for the set of pieces of content and the psychological parameter values included in the psychological profiles of the users that interacted with the set of pieces of content. Operation 208 may be performed by one or more hardware processors configured by machine-readable instructions including a component that is the same as or similar to correlation component 114, in accordance with one or more implementations.

An operation 210 may include identifying a set of prospective users for the prospective content based on the correlated one or more combinations of psychological parameter values and the psychological profiles of the users. Operation 210 may be performed by one or more hardware processors configured by machine-readable instructions including a component that is the same as or similar to prospective user identifying component 118, in accordance with one or more implementations.

An operation 212 may include effectuating, via the client computing platform, presentation of the psychological parameter values for the psychological parameters of the set of the prospective users. Operation 212 may be performed by one or more hardware processors configured by machine-readable instructions including a component that is the same as or similar to presentation effectuation component 116, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to identify a target audience for prospective content based on a taxonomy, the system comprising:
electronic storage configured to store i) taxonomical classifications of individual pieces of content, wherein individual taxonomical classifications include content parameter values for content parameters that define classifications for the individual pieces of content, ii) psychological profiles for users of digital environments, and iii) interaction information that characterizes interactions between users and the pieces of content via the digital environments, wherein the taxonomical classifications conform to a taxonomy that defines a hierarchical system of the content parameters that facilitate providing the pieces of content with the classifications, wherein the pieces of content are defined by and features of the individual pieces of content are characterized by the content parameter values for some or all of the content parameters, wherein the psychological profiles include psychological parameter values for psychological parameters; and
one or more processors configured by machine-readable instructions to:
receive, via a client computing platform, a content definition for prospective content, wherein the content definition includes content parameter values to a set of the content parameters for the prospective content;
identify a set of the pieces of content based on similarity between the taxonomical classifications of the individual pieces of content and the taxonomical classification of the prospective content as indicated by the content definition;
correlate one or more combinations of the psychological parameter values with the prospective content based on the interaction information that specifies interactions by particular ones of the users with the set of pieces of content and the psychological parameter values included in the psychological profiles of the particular users that interacted with the set of pieces of content;
identify a set of prospective users for the prospective content based on the correlated one or more combinations of psychological parameter values and the psychological profiles of the users; and
effectuate, via the client computing platform, presentation of the psychological parameter values for the psychological parameters of the set of the prospective users.

2. The system of claim 1, wherein the one or more processors are further configured by the machine-readable instructions to:
effectuate, via the client computing platform, presentation of the content parameters of the taxonomy to enable a requesting user to provide the content parameter values as the content definition.

3. The system of claim 1, wherein the content definition includes particular values to a game, a television show, a movie, a brand, an interest, an activity, a game mechanic, a brand, an art style, an application, an application feature, a theme, and/or a subscription.

4. The system of claim 1, wherein the psychological profiles are based on stated information.

5. The system of claim 4, wherein the stated information includes answers of the users to questions presented to the users.

6. The system of claim 1, wherein the psychological profiles are associated with and/or generated in relation with particular online games, online platforms, and/or online applications.

7. The system of claim 1, wherein the interaction information includes timing information, expense information, and/or movement information related to the interactions with the content.

8. The system of claim 1, wherein the interaction information includes whether the users have affinities for the individual pieces of content or aversions to the individual pieces of content.

9. The system of claim 8, wherein correlating the one or more combinations of psychological parameter values with the prospective content is based on the affinities of the users that interacted with the set of the pieces of content, wherein the correlations convey the one or more combinations of the psychological parameter values for users that have affinities for the set of the pieces of content.

10. The system of claim 1, wherein identifying the set of prospective users for the prospective content is performed by determining the psychological profiles with commonalities between the psychological parameter values and the one or more combinations of psychological parameter values.

11. A method to identify a target audience for prospective content based on a taxonomy, the method comprising:
receiving, by one or more processors via a client computing platform, a content definition for prospective content, wherein the content definition includes content parameter values to a set of content parameters for the prospective content, wherein taxonomical classifications of individual pieces of content are stored in electronic storage, wherein individual taxonomical classifications include different content parameter values for the content parameters that define classifications for the individual pieces of content, wherein the taxonomical classifications conform to a taxonomy that defines a hierarchical system of the content parameters that facilitate providing the pieces of content with the classifications, wherein the pieces of content are defined by and features of the individual pieces of content are characterized by the content parameter values for some or all of the content parameters;
identifying, by the one or more processors, a set of the pieces of content based on similarity between the taxonomical classifications of the individual pieces of content and the taxonomical classification of the prospective content as indicated by the content definition;
correlating, by the one or more processors, one or more combinations of psychological parameter values with the prospective content based on interaction information that specifies interactions by particular ones of the users with the set of pieces of content and the psychological parameter values included in psychological profiles of the particular users that interacted with the set of pieces of content, wherein psychological profiles for users of digital environments and the interaction information are stored in the electronic storage, wherein the psychological profiles include psychological parameter values for psychological parameters, wherein the interaction information characterizes interactions between the users and the pieces of content via the digital environments;
identifying, by the one or more processors, a set of prospective users for the prospective content based on the correlated one or more combinations of psychological parameter values and the psychological profiles of the users; and
effectuating, by the one or more processors via the client computing platform, presentation of the psychological parameter values for the psychological parameters of the set of the prospective users.

12. The method of claim 11, further comprising:
effectuating, via the client computing platform, presentation of the content parameters of the taxonomy to enable a requesting user to provide the content parameter values as the content definition.

13. The method of claim 11, wherein the content definition includes particular values to a game, a television show, a movie, a brand, an interest, an activity, a game mechanic, a brand, an art style, an application, an application feature, a theme, and/or a subscription.

14. The method of claim 11, wherein the psychological profiles are based on stated information.

15. The method of claim 14, wherein the stated information includes answers of the users to questions presented to the users.

16. The method of claim 11, wherein the psychological profiles are associated with and/or generated in relation with particular online games, online platforms, and/or online applications.

17. The method of claim 11, wherein the interaction information includes timing information, expense information, and/or movement information related to the interactions with the content.

18. The method of claim 11, wherein the interaction information includes whether the users have affinities for the individual pieces of content or aversions to the individual pieces of content.

19. The method of claim 18, wherein correlating the one or more combinations of psychological parameter values with the prospective content is based on the affinities of the users that interacted with the set of the pieces of content for the set of the pieces of content, wherein the correlations convey the one or more combinations of the psychological parameter values for users that have affinities for the set of the pieces of content.

20. The method of claim 11, wherein identifying the set of prospective users for the prospective content is performed by determining the psychological profiles with commonalities between the psychological parameter values and the one or more combinations of psychological parameter values.
